(19) United States
(12) Patent Application Publication
(10) Pub. No.: US 2013/0253960 A1
(43) Pub. Date: Sep. 26, 2013

(54) MANAGEMENT SYSTEM, METHOD AND DEVICE HAVING AN OUTPUT GENERATOR

(71) Applicant: APPLIED SYSTEMS, INC., University Park, IL (US)

(72) Inventors: JASON R. WOODS, OAK FOREST, IL (US); FRANK D. SMITH, FRANKFORT, IL (US); PHILIP J. SMITH, BEECHER, IL (US); JONATHAN D. GREIMAN, MOKENA, IL (US); MICHAEL F. CURIEL, CROWN POINT, IN (US); ROBERT S. GALLAGHER, NEW LENOX, IL (US)

(73) Assignee: APPLIED SYSTEMS, INC., University, IL (US)

(21) Appl. No.: 13/902,406

(22) Filed: May 24, 2013

Related U.S. Application Data
(63) Continuation-in-part of application No. 12/207,425, filed on Sep. 9, 2008.

(51) Int. Cl. G06F 17/30; G06Q 40/08

(52) U.S. Cl. CPC G06F 17/30194; G06Q 40/08
USPC 705/4; 707/827

(57) ABSTRACT

A system is configured to store different categories of business data. The system is accessible by one or more electronic devices. The system is operable to feed business output data to the electronic devices. The business output data is importable into other systems.

### PRIORITY CLAIM

This application is a continuation-in-part of, and claims the benefit and priority of, U.S. patent application Ser. No. 12/207,425, filed on Sep. 9, 2008, and the entire contents of such application are hereby incorporated by reference.

### CROSS REFERENCE TO RELATED APPLICATIONS

This application is related to the following commonly-owned, co-pending patent applications: U.S. patent application Ser. No. 12/207,449, filed on Sep. 9, 2008; U.S. patent application Ser. No. 12/207,448, filed on Sep. 9, 2008; U.S. patent application Ser. No. 12/207,442, filed on Sep. 9, 2008; U.S. patent application Ser. No. 13/536,593, filed on Jun. 28, 2012; U.S. patent application Ser. No. 13/612,117, filed on Sep. 12, 2012; U.S. patent application Ser. No. 13/857,686, filed on Apr. 5, 2013; and U.S. patent application Ser. No. 13/871,998, filed on Apr. 26, 2013.

### COPYRIGHT NOTICE

A portion of the disclosure of this patent document contains or may contain material which is subject to copyright protection. The copyright owner has no objection to the photocopy reproduction by anyone of the entire patent document in exactly the form it appears in the Patent and Trademark Office patent file or records, but otherwise reserves all copyrights whatsoever.

### BACKGROUND

Often, web based applications need to send documents to users. Typically, documents are sent via email and/or web download. Occasionally, web based application servers cause fax transmissions to occur. However, these server-initiated fax transmissions suffer from certain drawbacks.

First, these fax transmissions appear to come from a central source (i.e., a fax number associated with the application server). However, if the server is providing a web based application used by multiple different companies, each of these companies may want their fax transmissions to appear to come from their company with their specific set of assigned phone numbers (e.g., the fax transmissions may be going to customers of the company).

Second, transmission charges associated with web based fax transmission are incurred by the company that owns the application server. This then creates additional overhead for the application server company and/or a billing burden for the application server company trying to recover these fax transmission fees.

In addition, many companies use business software systems, such as customer relationship management (CRM) software systems. The companies separately use other software systems, such as financial software systems. They use their business software systems to periodically generate reports, which include specific types of information. To effectively run their businesses, these companies have to periodically update their separate software systems with the information from these reports.

The reports are not importable into the separate software systems. As a result, these companies must perform manual steps to input information into their separate software systems. This results in a labor burden. In addition, the manual steps have risks of human error. Also, the lack of automation has the risk that updates might not occur regularly in accordance with an optimal schedule.

Therefore, there is a need to overcome, or otherwise lessen the effects of, these disadvantages and shortcomings.

### SUMMARY

The present disclosure provides methods and apparatus for delivering documents via fax transmission that overcome these problems. A web based application server transmits a document to a distribution management system. The distribution management system then translates the document if necessary (e.g., from a proprietary format to a PDF and a fax) and sends the translated document to one or more destinations such as email inboxes, printers, and fax machines.

For fax deliveries, the distribution management system sends the document to a particular client device that is associated with the fax destination. For example, the client device that actually transmits the fax may reside at a company, and the fax machine may be at a customer of that company. In this manner, fax transmissions appear to come from the correct source (not the distribution management system), and transmission charges associated with the fax are incurred by the appropriate company (not the company associated with the distribution management system).

The business management system or system, in one embodiment, enables users to generate and manage customer accounts, vendors, invoices, transactions, records, data and activities related to a business, including, but not limited to, an insurance agency management business. The system, in one embodiment, incorporates customer relationship management (CRM) functionality and structure.

In one embodiment, the system includes an output generator. The output generator produces business data files in a format which is importable into a separate, software-based system of the user. Depending upon the embodiment, the business data files can include financial data files, and the separate system can include a software-based financial management system which incorporates an accounting system. The outcome generator is configurable to automatically feed the business data files to a network access device accessible to the user. The user can retrieve the data files from the device and import them into the separate system.

In one embodiment, the business management system includes a data storage device storage device configured to store different categories of business data related to a business. The data storage device stores a plurality of data fields related to the customers, vendors and invoicing of the business. The data storage device is accessible, over a network, by a processor and one or more network access devices or electronic devices. The electronic devices each have at least one data storage destination, or they are each associated with at least one data storage destination.

The system has a first connection instruction set stored within the data storage device. The first connection instruction set is installable onto each of the electronic devices. The system has a second connection instruction set stored within the data storage device. The second connection instruction set is executable by the processor to establish and maintain a connection with each of the electronic devices without requiring input from users.

The system has a plurality of instructions stored within the data storage device. The instructions are executable by the processor to: (a) receive a plurality of settings and (b) send an output data file to the data storage destinations in accordance with the settings. The output data file has a format which is importable into a separate software-based system, including, but not limited to, an electronic financial management system.

In one embodiment, the settings include:
(a) a path setting associated with the data storage destinations of the electronic devices;
(b) an output setting which specifies at least one of the categories of the business data to be included within the output data file;
(c) a schedule setting which specifies how often the electronic devices are to receive the output data file; and
(d) a user permission setting which specifies a permission to change at least one of the settings.

In one embodiment, the schedule setting specifies a recurring frequency for the processor to send the output data files to the data storage destinations. In one embodiment, the output data file has a plain text format. The plain text format is associated with a plurality of other data fields separated by breaks. In one embodiment, the output data file includes a Comma Separated Value (CSV) data file. In one embodiment, the output data file includes General Ledger (GL) accounting data.

In one embodiment, the instructions are executable by the processor to: (a) receive a selection of at least one of the categories of business data; (b) store a data file template based on the selection; and (c) generate the output data file according to the data file template.

In one embodiment, the instructions are executable by the processor to: (a) receive a selection of at least one of a plurality of file descriptor categories; (b) generate file descriptor data corresponding to the selection; and (c) send the file descriptor data in association with the output data file.

In one embodiment the business data includes different categories of financial data, the output data file includes General Ledger data, the output setting specifies at least one of the categories of the financial data to be included within the output data file, and the separate system is a financial management system. The instructions are executable by the processor to send the output data file to the data storage destination in accordance with the settings. The output data file has a format which is importable into a software-based financial management system.

Additional features and advantages of the present invention are described in, and will be apparent from, the following Brief Description of the Figures and Detailed Description.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a system for delivering documents.

FIG. 4 is a schematic block diagram illustrating one embodiment of the system coupled to a network accessible to electronic network access devices or electronic devices.

FIG. 5 is a schematic block diagram illustrating one embodiment of the system coupled to a network accessible to electronic network access devices or electronic devices within region A and electronic network access devices or electronic devices within region B.

FIG. 6 is a schematic block diagram illustrating one embodiment of the system coupled to a network accessible to a single electronic network access device or electronic device.

FIG. 7 is a schematic block diagram illustrating one embodiment of the business management system or system having the distribution management system, business management instructions, output generator and business data fields.

FIG. 8 is a view of one example of one embodiment of the home interface of the system.

FIG. 9 is a view of one example of one embodiment of the configure interface of the system.

FIG. 10 is a view of one example of one embodiment of the device registration interface of the system.

FIG. 11 is a view of one example of one embodiment of the device registration interface of the system, illustrating examples of registered network access device or electronic devices.

FIG. 12 is a view of one example of one embodiment of the associate interface of the system.

FIG. 13 is a view of one example of one embodiment of the device available interface of the system.

FIG. 14 is a view of one example of one embodiment of the network path interface of the system.

FIG. 15 is a schematic block diagram illustrating one embodiment of the system coupled to a network accessible to electronic network access devices or electronic devices, illustrating the output of a General Ledger (GL) data file in tabular format followed by the importing of such data file into a financial management system.

FIG. 16 is a view of one example of one embodiment of the data file mapping interface of the system.

FIG. 17 is a view of one example of one embodiment of the spreadsheet version of the tabular data file output by the system.

### DETAILED DESCRIPTION

Business Management System

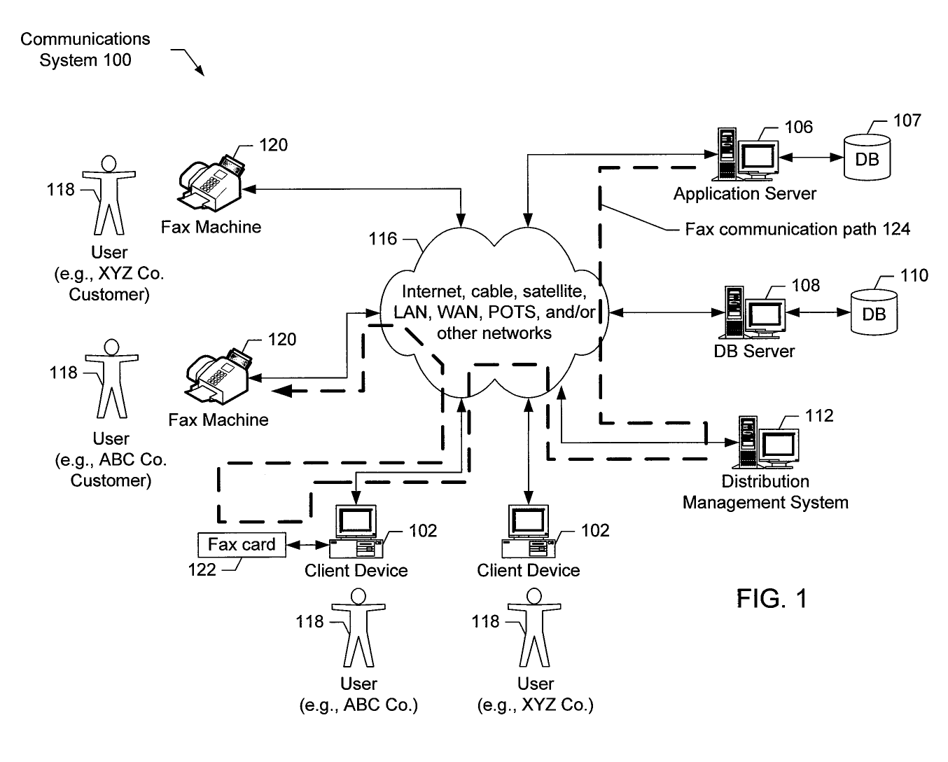

The present system is most readily realized in a network communications system. A high level block diagram of an exemplary network communications system 100 is illustrated in FIG. 1. The illustrated system 100 includes one or more client devices 102, one or more application servers 106, one or more database servers 108 connected to one or more databases 110, a distribution management system 112, and one or more fax machines 120. As described in more detail below, each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

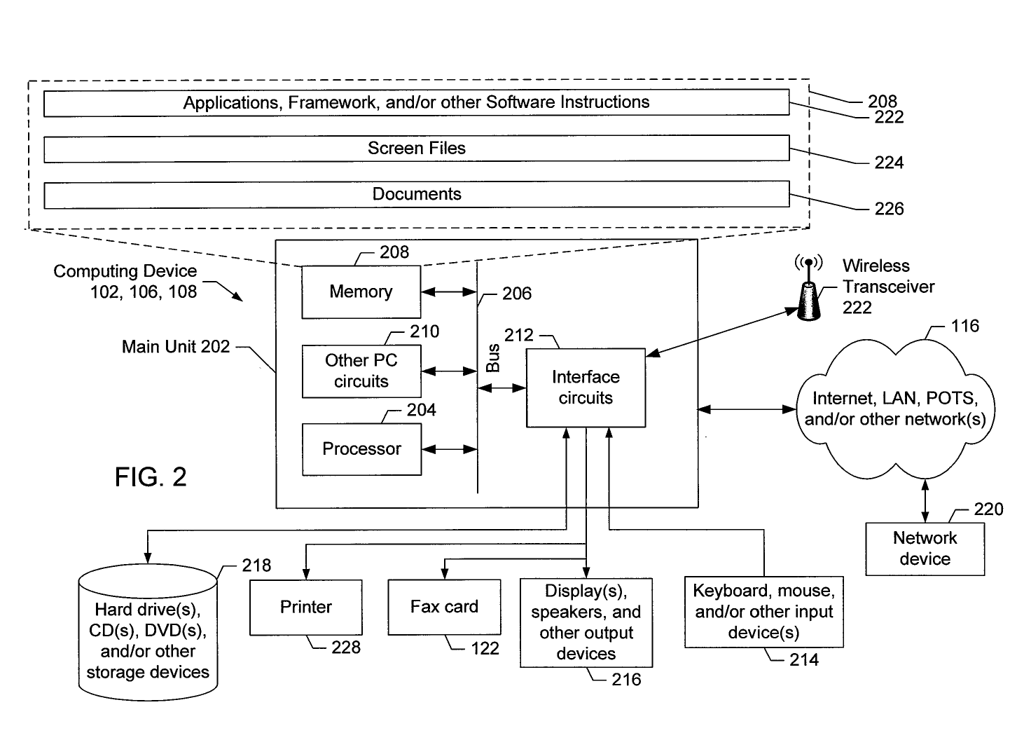

A detailed block diagram of an example computing device 102, 106, 108 is illustrated in FIG. 2. Each computing device 102, 106, 108 may include a server, a personal computer (PC), a personal digital assistant (PDA), and/or any other suitable computing device. Each computing device 102, 106, 108 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions 222 that interact with the other devices in the system 100 as described herein. These software instructions 222 may be executed by the processor 204 in any suitable manner. The memory 208 and/or another storage device 218 may also store one or more data structures, digital data indicative of documents, files, programs, web pages, etc. retrieved from another computing device 102,106, 108 and/or loaded via an input device 214.

The example memory device 208 stores software instructions 222, screen files 224, and documents 226 for use by the system as described in detail below. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, speakers, and/or other output devices 216 may also be connected to the main unit 202 via the interface circuit 212. The display may be a cathode ray tube (CRTs), liquid crystal displays (LCDs), or any other type of display. The display generates visual displays of data generated during operation of the computing device 102, 106, 108. For example, the display may be used to display screen files received from the application server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 106, 108.

Each computing device 102, 106, 108 may also exchange data with other computing devices 102, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users 118 of the system 100 may be required to register with the application server 106. In such an instance, each 118 user may choose a user identifier (e.g., e-mail address) and a password which may be required for the activation of services. The user identifier and password may be passed across the communication channel(s) 116 using encryption built into the user's browser, software application, or computing device 102, 106, 108. Alternatively, the user identifier and/or password may be assigned by the application server 106.

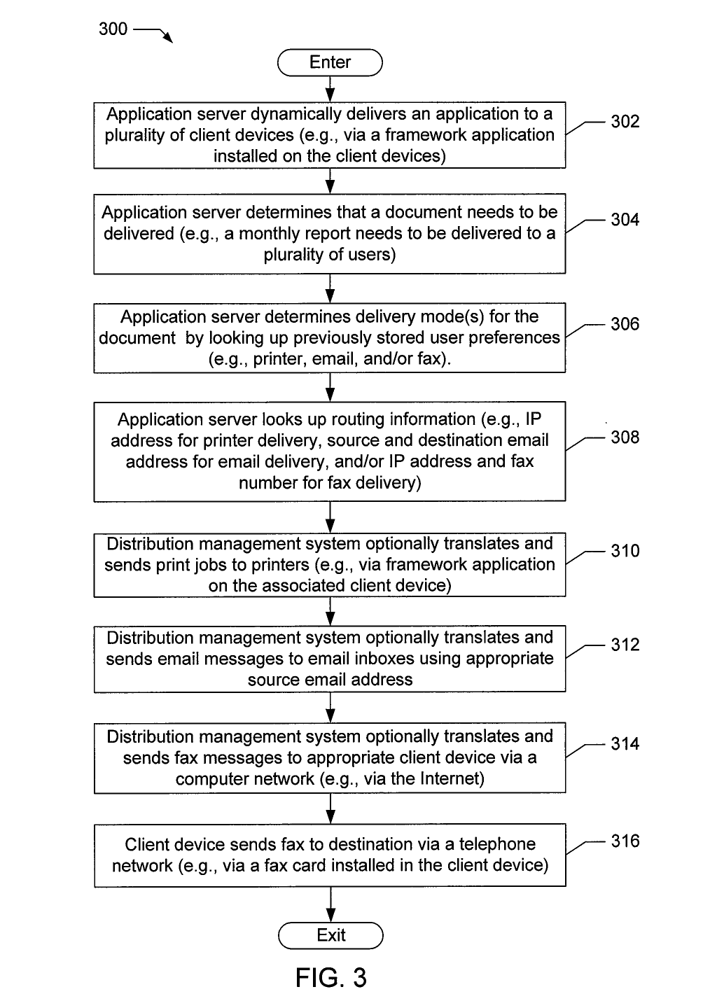

A flowchart of an example process 300 for delivering documents is presented in FIG. 3. Preferably, the process 300 is embodied in one or more software programs which are stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, some of the steps described may be optional, and additional steps may be included.

In general, the process 300 causes an application server 106 to transmit a document to the distribution management system 112. The distribution management system 112 then translates the document if necessary. For example, the distribution management system 112 may translate the document to and/or from a proprietary format, a spreadsheet format, a delimited format such as a comma separated values (CSV) format, a word processing format, a PDF format, and/or a fax format). The distribution management system 112 then sends the document and/or the translated document to one or more destinations such as email inboxes, printers, and fax machines 120. For fax deliveries, the distribution management system 112 sends the document to a particular client device 102 that is associated with the fax destination. For example, the client device 102 that actually transmits the fax may reside at a company, and the fax machine 120 may be at a customer of that company. In this manner, fax transmissions appear to come from the correct source (not the distribution management system 112), and transmission charges associated with the fax are incurred by the appropriate company (not the company associated with the distribution management system 112).

More specifically, the application server 106 begins the example process 300 by dynamically delivering an application to a plurality of client devices (block 302). Preferably, the application server 106 may transmit data indicative of screen displays to a framework application running on the client device 102. For example, the application server 106 may transmit data indicative of screen displays for an insurance agency application to the client device 102. In response to users 118 at the client devices 102, the application server 106 receives events and data from the framework applications running on the client devices 102. For example, a user 118 may click a mouse on a drop down menu at the client device 102. As a result, the client device 102 sends an event to the application server 106. The application server 106 then responds to the client device 102 with data to populate the drop down menu. If the user 118 selects an item from the drop down menu, the client device 102 sends data indicative that selection to the application server 106. In this back-and-forth manner, the business logic of one or more applications is delivered from the application server 106 to the client devices 102.

When executing these applications, the application server 106 may retrieve data from a local database 107 and/or a remote database 110 via a database server 108. For example, the application server 106 may retrieve the data to populate the drop down menu in the example above. In another example, the application server 106 may store data entered by a user 118 in a database 107, 110 for later retrieval and display at a client device 102.

Often, the application server 106 may need to send one or more documents to a plurality of users 118 (block 304). For example, the application server 106 may need to send a monthly report to several different users 188. Next, the distribution management system 112 determines one or more delivery modes for the document by looking up previously stored user preferences (block 306) and looks up any necessary routing information (block 308).

Some users 118 may want to have the report delivered directly to their local printer 228. Accordingly, the distribution management system 112 sends the print job directly to the associated client device 102 (block 310). The distribution management system 112 is given access to each user's printers via the framework application running on that user's client device 102.

Some users 118 may want to have the report delivered via email and/or to a fax machine 120. Preferably, one distribution management system 112 is used by multiple companies (e.g., hundreds). For example, the application server 106 may be serving a software application used by ABC Co. and XYZ Co. Each of these companies may need to send documents to their customers. For example, ABC Co. may need to send a monthly report to ABC Co. Customer, and XYZ Co. may need to send a monthly report to XYZ Co. Customer.

Preferably, communications from the distribution management system 112 to a customer should appear to come from the company associated with that customer, not from the distribution management system 112. Accordingly, emails are sent to directly to users 118 from the distribution management system 112 via the network 116 using an “from” email address indicative of the company associated with the customer (block 312). However, to prevent the email from being captured by a spam filter, the email address is not spoofed. For example, the sender's email address may be documents_for_abc@dms.com for documents that need to appear to come from ABC Co. and documents_for_xyz@dms.com for documents that need to appear to come from XYZ Co. In other words, the example email messages are actually being sent from the “dms.com” domain. However, the full email address of the sender changes depending on the destination.

In addition, the “reply” email address changes depending on the destination. However, in this case, spam filters are generally not an issue. Therefore, the reply email address is set to the actual companies email address. For example, the reply email address may be user@abc.com for documents that need to appear to come from ABC Co. and user@xyz.com for documents that need to appear to come from XYZ Co.

In order to make faxes of documents appear to come from the company associated with a customer, the distribution management system 112 routes faxes through a fax card 122 in a client device 102 of the company (blocks 314 and 316). The distribution management system 112 is given access to each user's fax card (if installed) via the framework application running on that user's client device 102. Preferably, the framework application is downloaded from the application server 106 and installed on the client device 102.

An example of a complete fax communication path 124 is illustrated in FIG. 1. In this example, the application server 106 sends the document to the distribution management system 112 via the Internet. As an example, this document may be a monthly report in a proprietary format or a word processing format. If necessary, the distribution management system 112 then converts the document. For example, the distribution management system 112 may convert the proprietary file to a PDF for delivery to a printer and/or an email inbox, and the distribution management system 112 may convert the proprietary file to a fax document for delivery to a fax machine. The distribution management system 112 then sends the document and/or translated document to the appropriate client device 102 via the Internet. Once the document is received by the client device 102, the client device 102 faxes the document to the destination fax machine via an installed fax card 122 and a telephone network. In this manner, ABC Co. is the source of the fax transmission and incurs the associated fax charges.

In summary, persons of ordinary skill in the art will readily appreciate that methods and apparatus for delivering documents have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

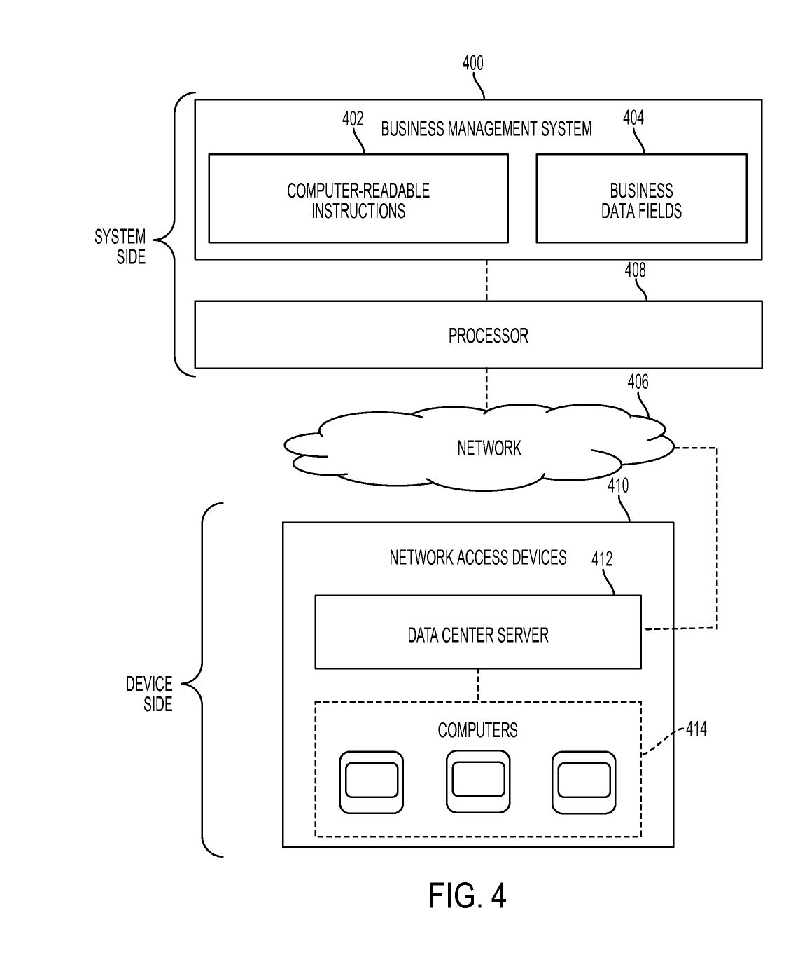

In one embodiment illustrated in FIG. 4, the business management system 400 or system 400 includes a plurality of computer-readable instructions 402 and business data fields 404. The business data fields 404 are fillable with business data, including, but not limited to, customer data, vendor or supplier data, and invoicing data. The system 400 is accessible, over network 406, by the processor 408. The system 400 is also accessible, over network 406, by one or more electronic network access devices or electronic devices 410. In the example illustrated in FIG. 4, the user is an insurance agency management company with a central data center. The company's data center has a data center server 412 accessible by a plurality of computers 414. The server 412 is coupled to the system 400 through the network 406.

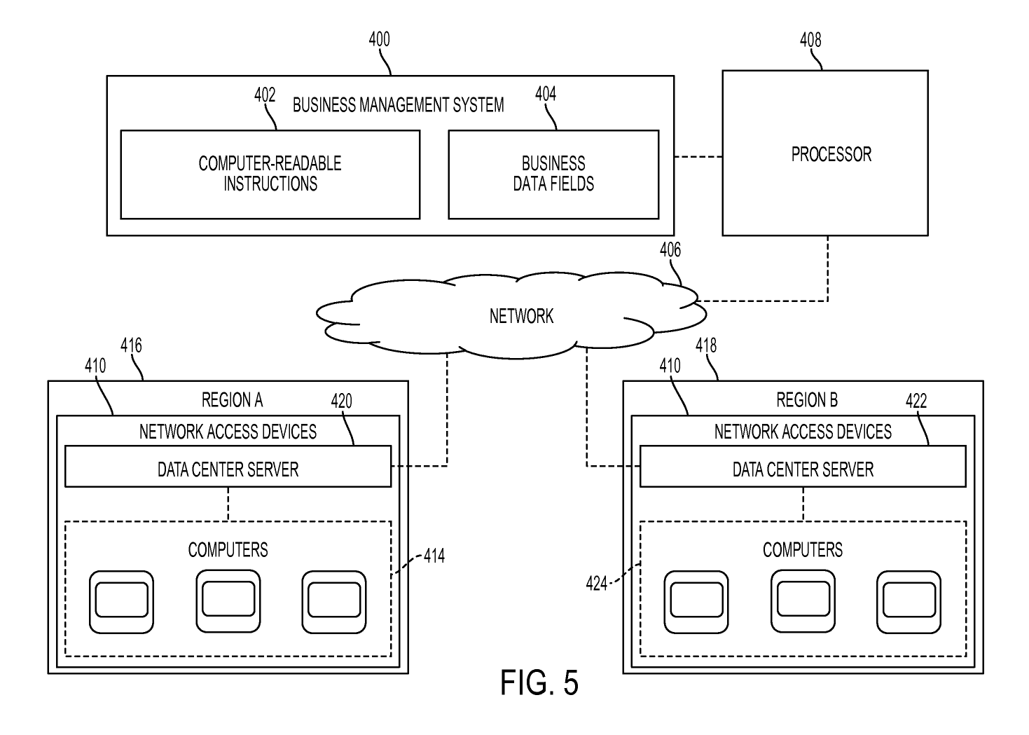

In the example illustrated in FIG. 5, the user is an insurance agency management company with a data center 416 in region A, such as the West Coast of the USA. The insurance agency management company also has a data center 418 in region B, such as the East Coast of the USA. The company's region A data center has a region A server 420 accessible by a plurality of computers 414. The region A server 420 is coupled to the business management system 400 through the network 406. The company's region B data center has a region B server 422 accessible by a plurality of computers 424. The region B server 422 is coupled to the business management system 400 through the network 406.

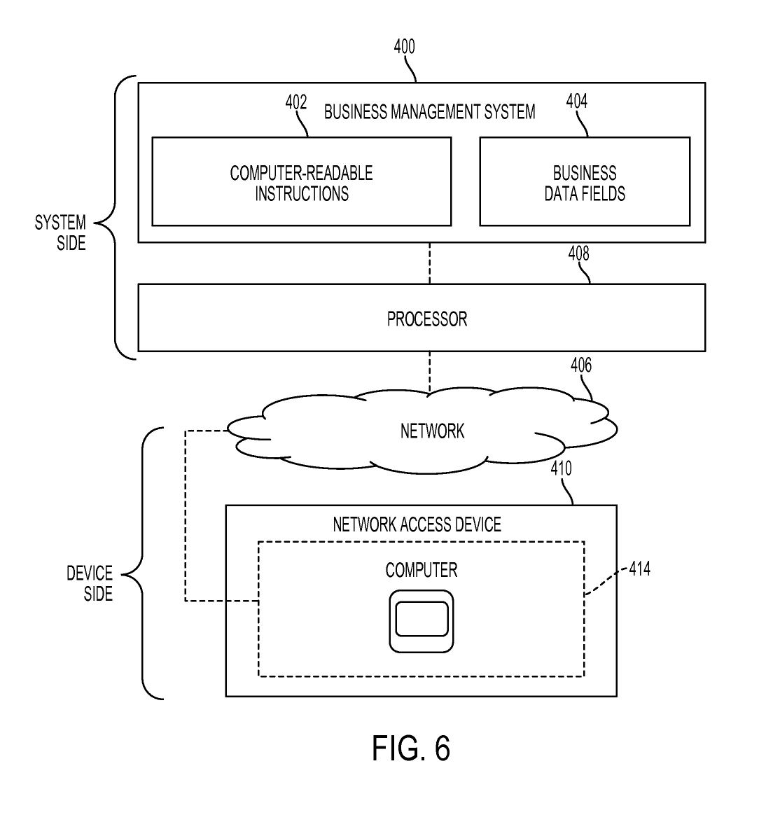

In the example illustrated in FIG. 6, the user is an insurance agent. The agent's computer 414 is coupled to the business management system 400 through the network 406.

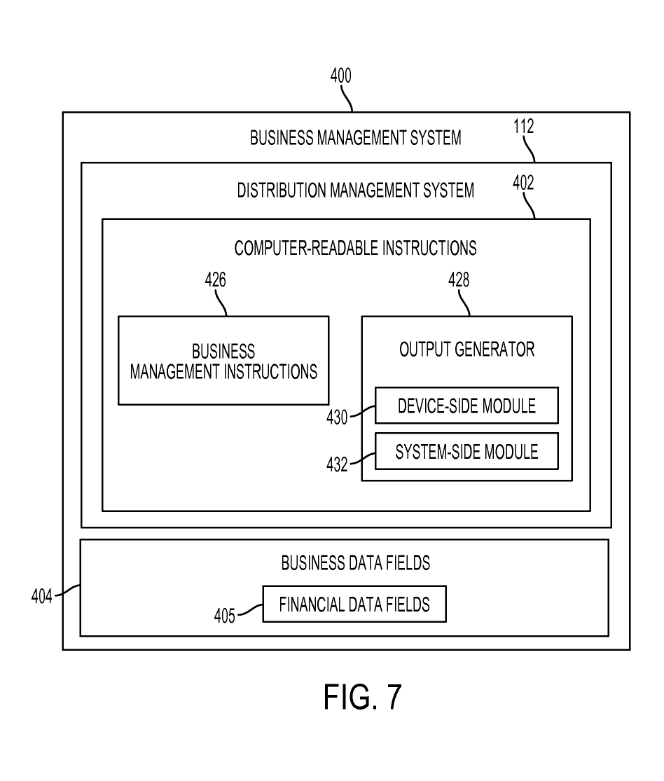

In one embodiment illustrated in FIG. 7, the business management system 400 includes the distribution management system 112 described above, including all of the logic, structure, elements and functionality of the distribution management system 112. In one embodiment, the distribution management system 112 includes the computer-readable instructions 402 which, in turn, include the business management instructions 426 and the output generator 428.

The output generator 428, in one embodiment, includes the device-side instruction set or device-side module 430 and the system-side instruction set or system-side module 432. The data storage device of the system 400 stores a downloadable copy of the device-side module 430. The device-side module 430, described in detail below, is installable onto one or more of the network access devices 410. Using client-server terminology, the devices 410 have the roles of clients, and the device-side module 430 is installable on the client-side. The system-side module 432, described in detail below, resides in the data storage device of the system 400. Using client-server terminology, the processor 408 has the role of the server, and the system-side module 432 is installable on the server-side.

In one embodiment, the device-side module 430 includes a data interface program or channel computer program loadable into the memory or data storage device of the network access device 410. The system-side module 432, residing within the system 400, includes a counterpart channel computer program executable by the processor 408. When the device-side module 430 is installed on a device 410, it is executable to interact with the system-side module 432. The interaction enables the system processor 408 to feed output files to the device 410 without requiring a login or other action from the user.

In one embodiment, the communication or connection modules 430 and 432 are associated with a channel or data port. Based on the instructions of the modules 430 and 432, the system processor 408 establishes and maintains a connection with the device 410. The system processor 408 sends, pushes or otherwise feeds the output files through the data port to the device 410.

In one embodiment, the network access device 410 has a Microsoft Windows® operating system. The operating system implements a set of communication protocols, such as the TCP/IP protocol suite on which the Internet runs, which includes the Transmission Control Protocol (TCP) and the Internet Protocol (IP). The system processor 408, as directed by connection modules 430 and 432, functions with the TCP/IP stack of the device 410 and the system-side connection module 432 to maintain or persist a connection with the device 410. With each output from the generator 428, the system processor 408 sends output files to the device 410 through a data port determined by the TCP/IP stack implementation on the device 410.

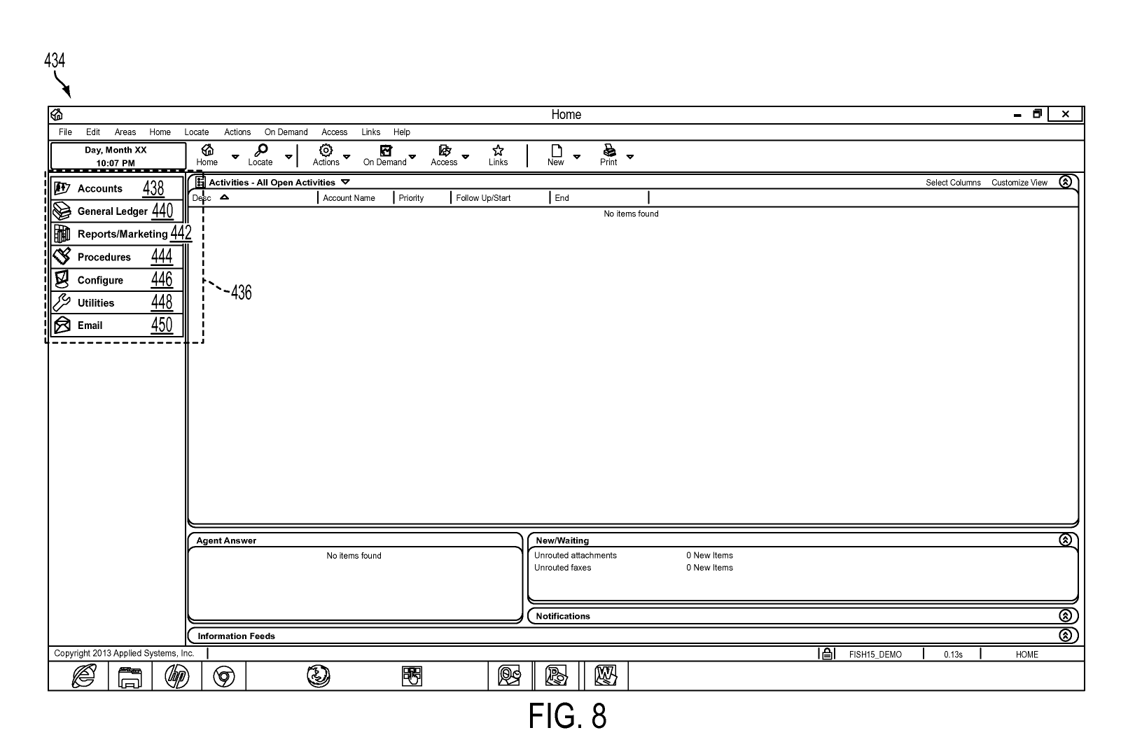

In one embodiment illustrated in FIG. 8, the system 400 is an insurance agency management system accessible over the network 406. The insurance agency management system 400 provides data structures, graphical user interfaces and modules for use by insurance agents or insurance agency firms or companies. The insurance agency management system 400 has modules and data fields to facilitate the management of communications, information flow, business data (including, but not limited to, financial data), insurance-related transactions and activities involving the agent, the agent's clients or customers, insurance policies, insurance claims, insurance carriers and other vendors.

In this embodiment, the system 400 is operable by the system processor 408 to generate a plurality of graphical user interfaces accessible by one or more electronic devices 410 used by insurance agents. The example home interface 434, shown in FIG. 8, displays a vertical menu 436 of insurance management modules, including the insurance accounts module 438, general ledger module 440, reports/marketing module 442, procedures module 444, configure module 446, utilities module 448 and email module 450. Each of these modules has a plurality of business data fields 404 associated with the purpose of the module. The data fields 404 are configured to receive, or be filled with, a variety of different types or categories of business data. Each category of business data is associated with one of these modules. The accounts module 438 enables the agent to view, edit and enter business data related to the agent's client accounts. The general ledger module 440 enables the agent to view, edit and enter business data related to finances, in particular financial data, including, but not limited to, accounting data, related to the agent's insurance agency business. The reports/marketing module 442 enables the agent to view business data contained in reports related to the agent's insurance agency business. The procedures module 444 enables the agent to view, edit and enter business data set forth in operating procedures related to the agent's insurance agency business. The configure module 446 enables the agent to customize features, settings and options of the system 400. The utilities module 448 enables the agent to use designated utilities, and the email module 450 enables the agent to send and receive emails for client and insurance carrier communications. The example home interface 434 also displays horizontal menus of the following modules: File, Edit, Areas, Home, Locate, Actions, On Demand, Access, Links, Help, New, and Print.

In one embodiment, to enable or configure the output generator 428, the user takes the steps described as follows:

TABLE A

| CONFIGURATION STEP | DESCRIPTION |
|---|---|
| 1: Client-Install Step | Install or load a copy of the device-side |
| | module 430 onto a desired device as |
| | described in detail below. |
| 2: Registration Step | Register the loaded device as described in |
| | detail below. |
| 3: Path Step | Specify one or more network paths or data |
| | storage paths for the registered device as |
| | described in detail below. |

In the Client-Install Step 1 of Table A, referring to FIG. 7, the user chooses or otherwise selects a computer, server or other network access device to connect to the output generator 428 of the system 400. After making that choice, the user installs a copy of the device-side module 430 onto the selected device. In one embodiment, the system 400 displays a download link (not shown) to the user. The user clicks the download link, and the system 400 enables the selected device to store a copy of the device-side module 430 onto the hard drive, memory device or other data storage device of the selected device. As described above, the device-side module 430, when stored on the selected device, functions as a data interface enabling automatic data feeds from the system 400 to the selected device.

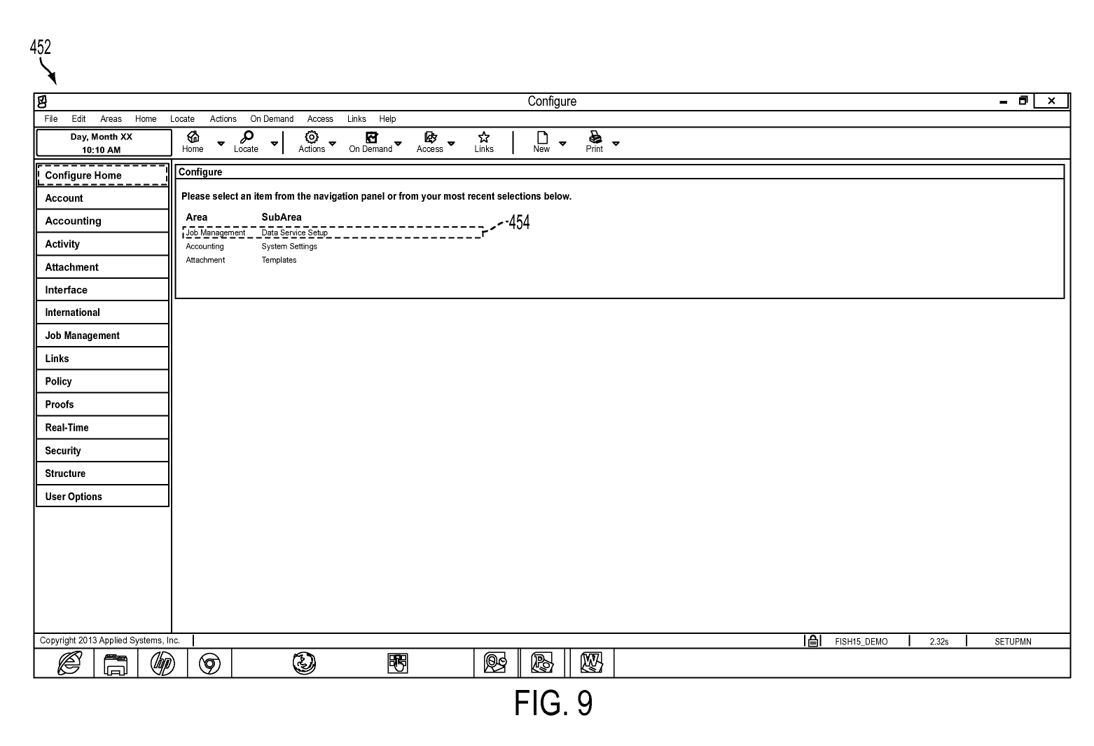

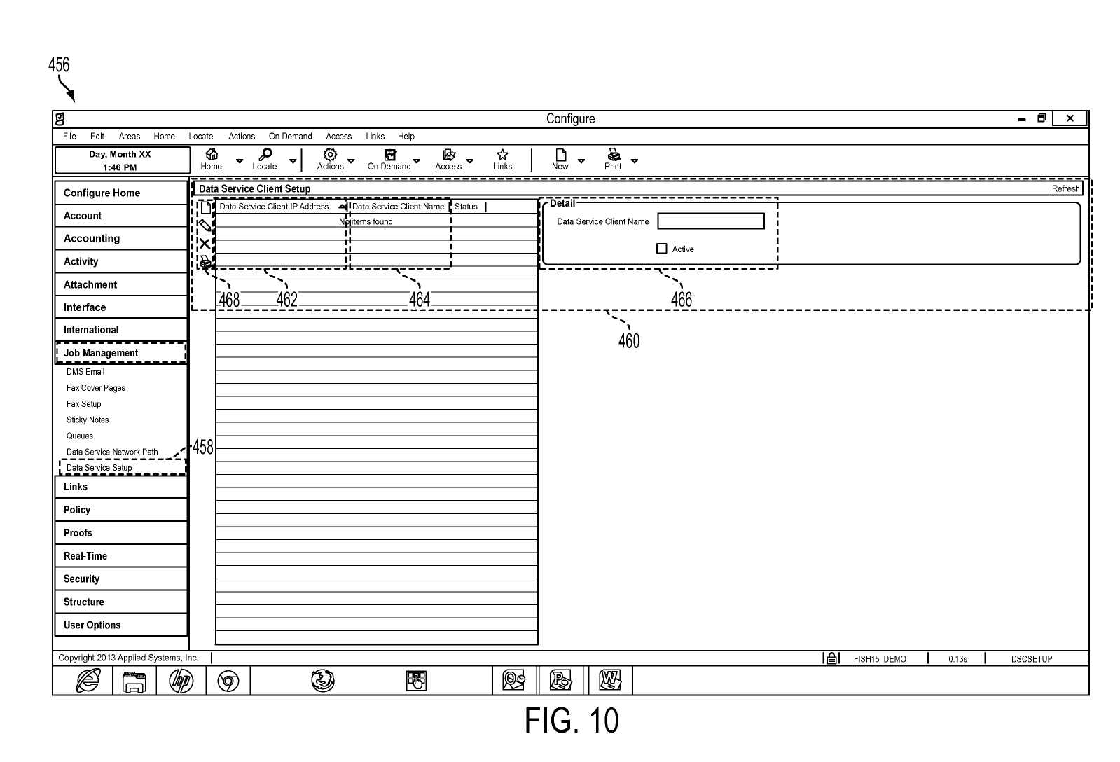

In the Registration Step 2 of Table A, the user may select the configure module 446 illustrated in FIG. 8. When the user selects the configure module 446, the system 400 displays the configure interface 452 illustrated in FIG. 9. The configure interface 452 displays an output generator setup link 454 named, “Data Service Setup.” When the user selects the output generator setup link 454, the system 400 displays the device registration interface 456 as illustrated in FIG. 10. The device registration interface 456 displays a device setup link 458 coupled to a device registration section 460.

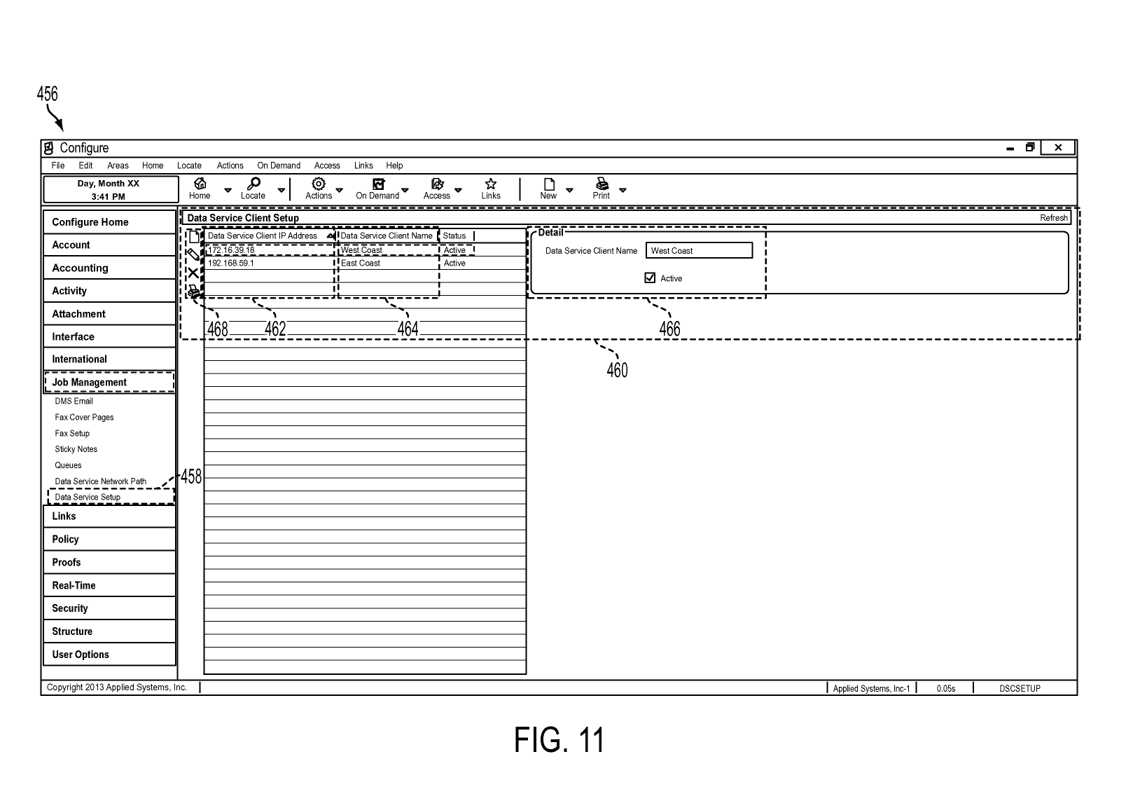

As illustrated in FIGS. 10-11, the device registration section 460 includes a network address section 462, a device name section 464 and a detail section 466. The network address section 462 includes selectable add, edit, delete and print symbols 468 enabling the user to add, edit, delete or print one or more network addresses of one or more of the devices.

In the example illustrated, the user registered two Internet Protocol (IP) addresses for two registered devices. In this example, the devices are servers of the user's insurance agency management firm. One server is located at the firm's West Coast data center, and the other server is located at the firm's East Coast data center. The first IP address is 172.16.39.18, and the second IP address is 192.168.59.1.

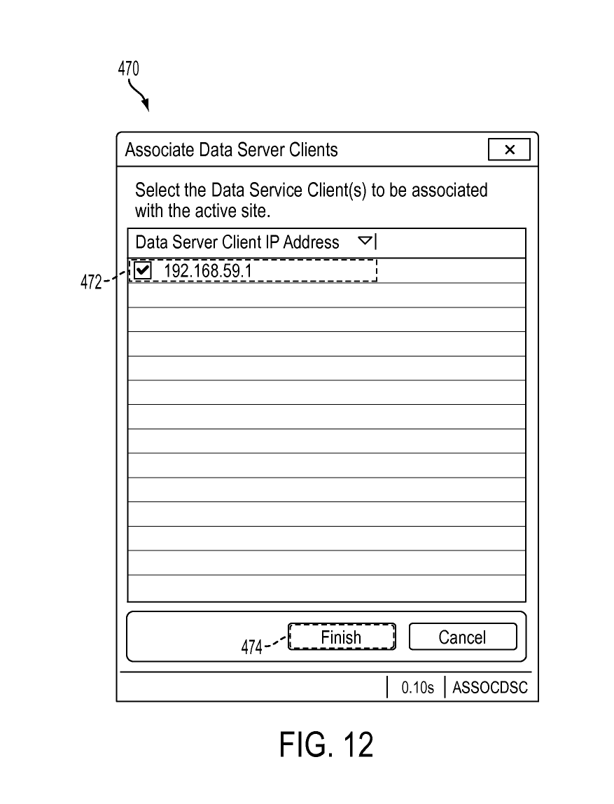

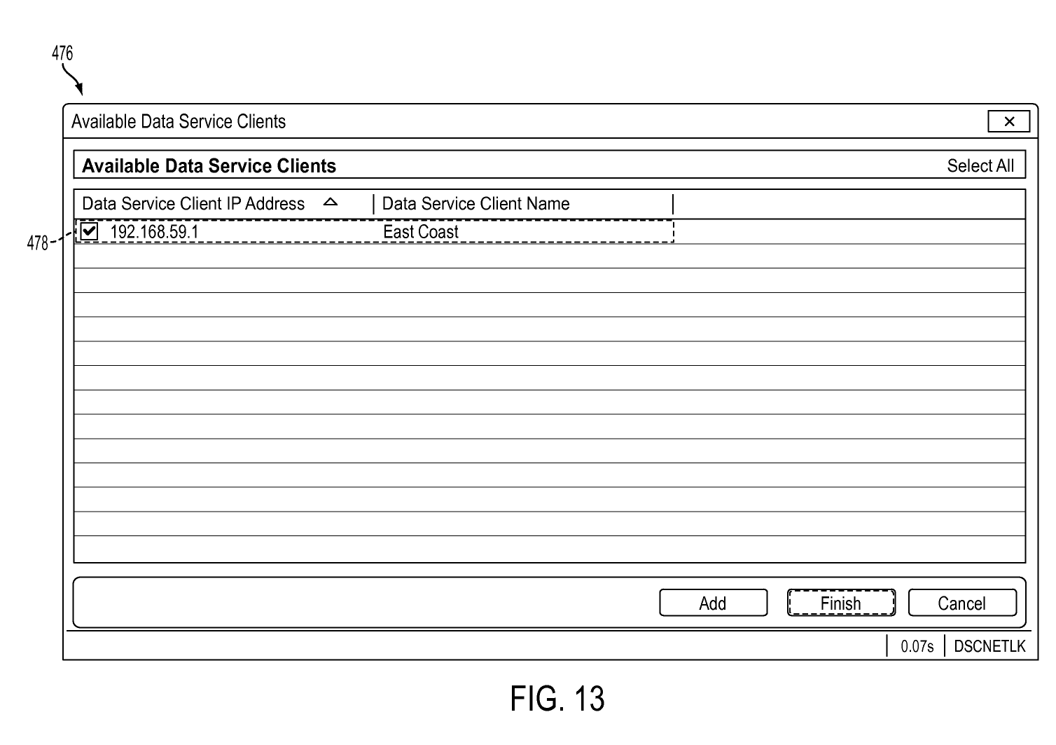

The system 400 displays an associate interface 470, illustrated in FIG. 12. The associate interface 470 enables the user to associate the IP addresses with desired servers. In the example illustrated in FIG. 12, the user placed a checkmark in box 472 to start the process of associating IP address, 192.168.59.1, with a desired server. After the user selects the Finish button 474, the system 400 displays the device available interface 476 as illustrated in FIG. 13. The device available interface 476 displays the devices which have been registered as described above. In the example illustrated in FIG. 13, the device available interface 476 displays the East Coast server as an available or registered device. By adding a checkmark to box 478, the user associates the 192.168.59.1 IP address with the East Coast server. The user would carry out the same process to associate the 172.16.39.18 IP address with the West Coast server.

In the Path Step 3 of Table A, continuing with the example illustrated in FIGS. 10-13, the user specifies the network paths or storage location paths for the registered devices. A path can lead to a local storage device of a registered device, or a path can lead to a network-based storage device of a registered device. In this example, the registered devices are the East Coast server and West Coast server of the insurance agency management firm.

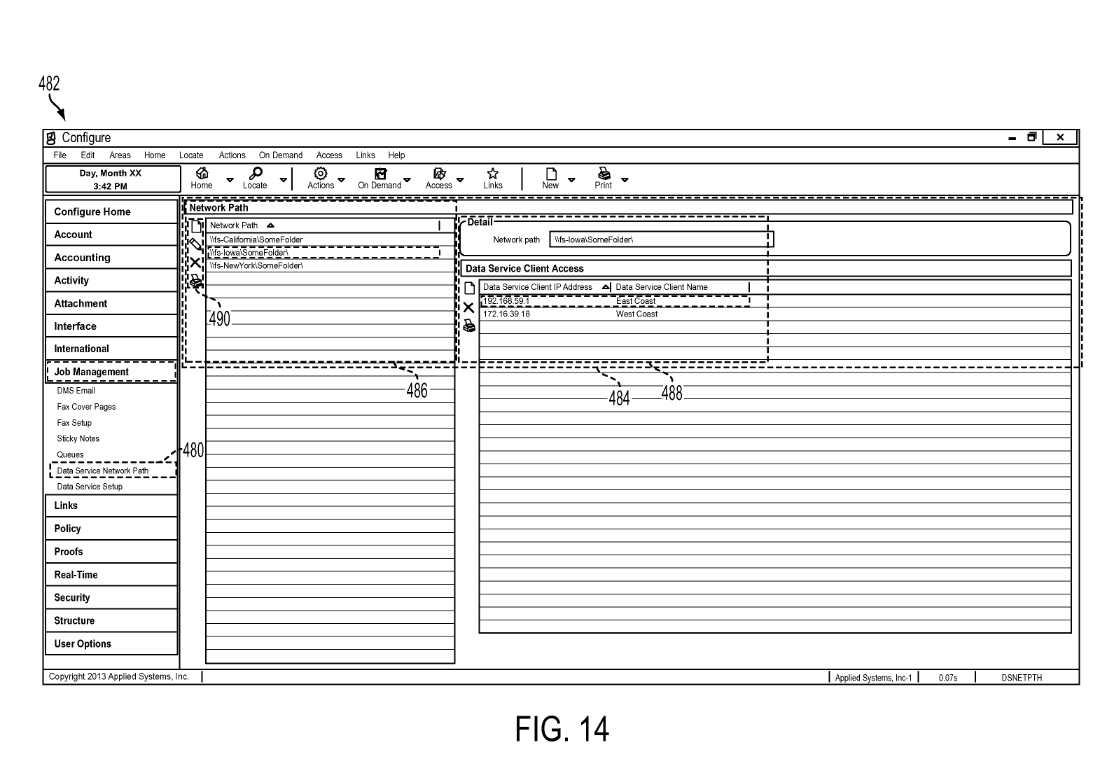

Referring to FIG. 14, when the user clicks the network path link 480, the system 400 displays the network path interface 482. The network path interface 482 displays a network path setup section 484 which includes a network path management section 486 and a network path detail section 488. The management section 486 includes a plurality of path fields and management links 490. The management links 490 include selectable add, edit, delete and print symbols.

The user uses the links 490 to enter one or more network paths or data storage paths. In this example, the user entered the following network paths:

(a) \\fs-California\SomeFolder\

(b) \\fs-Iowa\SomeFolder\

(c) \\fs-NewYork\SomeFolder\

These paths specify data storage destinations within data recording mediums. The data recording mediums are within, or associated with, the registered devices 410. In one embodiment, the data recording mediums are hard drives, memory devices or other data storage devices of the registered devices 410. In such embodiment, the paths specify locations or destinations within the directories or folders of the registered devices 410.

The interface 482 also enables the user to associate each of the paths with one of the registered devices 410. In the example illustrated, the user elected to associate the \\fs-Iowa\SomeFolder\ path with the East Coast server. The same process would apply for associating paths with the West Coast server. After the user has specified the desired network paths for the registered devices 410, the user has completed the process of enabling or configuring the output generator 428 for use.

In the example described, the regional configuration for the East and West Coast data centers conforms to the architecture illustrated in FIG. 5. This type of architecture can provide increased data exchange efficiency for a firm with multiple offices or data centers located relatively far apart. For example, the firm may have a main information technology (IT) center on the West Coast of the USA, and the firm may have a satellite IT center on the East Coast of the USA. The West Coast IT center serves the client computers of the insurance agents on the West Coast, and the East Coast IT center serves the client computers of the insurance agents on the East Coast. If all of the client computers on the East Coast had to exchange data with the server on the West Coast, the data exchange process could be relatively lengthy. Having regional servers serve their associated client computers can decrease the data exchange time and facilitate data access for the insurance agents.

The architecture illustrated in FIG. 5 can also enhance security for a firm with IT centers designated for different functions. For example, a firm may have server X which manages personal insurance policies and server Y which manages commercial insurance policies. If the output generator 428 were active for both servers, the system 400 could separately feed output data to the different servers. This would prevent server X from receiving commercial-related output, and this would prevent server Y from receiving personal-related output.

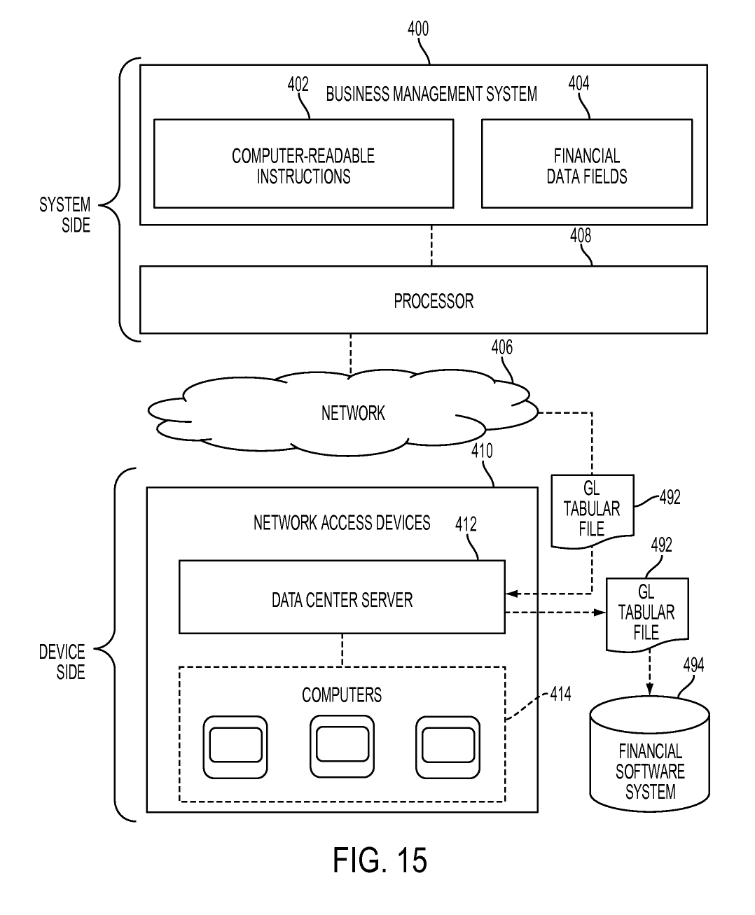

Referring to FIGS. 7 and 15, in one embodiment, an insurance agency management firm uses the system 400 to generate invoices, billings, statements and perform other activities related to insured parties, insurance providers, insurance agents and other parties involved with the business. The system 400 receives business data from the agency users, and the system 400 populates its business data fields 404 with the received business data.

In one embodiment illustrated in FIG. 7, the business data fields include financial data fields 405, which are filled with financial data, including invoice-related data, provided by the users. In some circumstances, the agency management firm has a financial management system or financial software system 494. Depending upon the type of financial software system 494, the system 494 may include or incorporate an online or offline, software-based accounting system or accounting module. The output generator 428 is operable to feed tabular financial data files to the registered devices. The user can then import those tabular data files into the financial software system 494.

In other circumstances, the agency management firm has an additional software-based system other than, or in addition to, a financial management system. Depending upon the type of the additional software-based system, the additional system may include or incorporate an online or offline, software-based system. The output generator 428 is operable to feed tabular business data files to the registered devices. The user can then import those tabular data files into the additional software system.

In one example, a national insurance agency management firm may have a main office and multiple satellite offices. The main office may have a main financial software system 494 with accounting functionality. Each satellite office uses the insurance agency management system 400. The main office may require the satellite offices to submit their financial data to the main office once per month or once per quarter. The output generator 428 enables the satellite offices to produce their financial data in a tabular format which is directly importable into the main financial software system 494.

Depending upon the embodiment, the financial data can include accounting information, accounting records or other data related to insurance policy management. In the embodiment illustrated in FIG. 15, the output generator 428 is operable to output financial General Ledger (GL) data in the form of tabular GL files, such as Comma Separated Value (CSV) export data files 492. Because of the tabular format, the user is able to electronically upload, transfer or otherwise import the tabular GL data files into the user's financial software system 494.

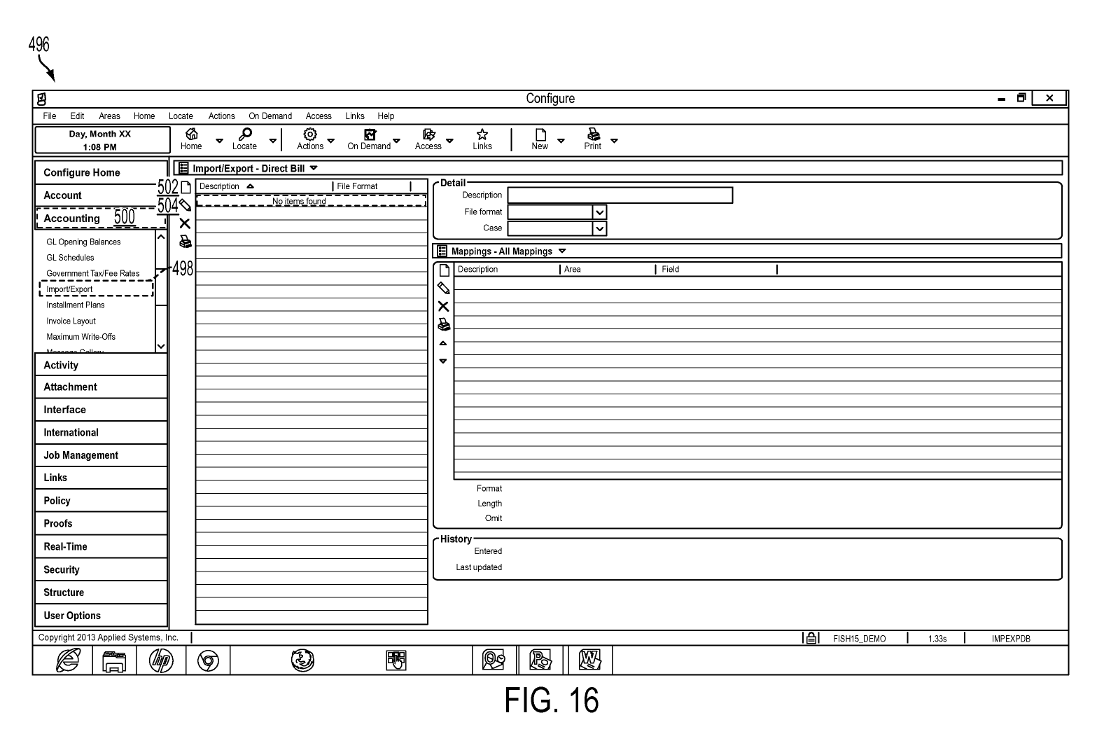

In one embodiment, the system-side module 432 of the output generator 428 includes a plurality of computer-readable instructions related to managing the GL data files output by the output generator 428. The system processor 408, executing such instructions, generates a plurality of graphical user interfaces which enable the user to manage the production and output of these GL data files. In one embodiment illustrated in FIG. 16, the system 400 displays the data file specification interface or data file mapping interface 496. The user may access the data file mapping interface 496 by clicking on the Import/Export link 498 within the Accounting module 500. The mapping interface 496 enables the user to define a plurality of different templates for GL data files to be generated by the output generator 428.

In one embodiment, the system 400 stores one or more customizable, selectable data file templates. The user may select the Add symbol 502 to select a customizable, pre-stored data file template. The selectable edit symbol 504 enables the user to customize the template. For customization purposes, the data file mapping interface 496 enables the user to customize several categories of file data, including, but not limited to: (i) the GL Account Balance categories set forth in Table B below; (ii) the Totals categories set forth in Table C below; and (iii) the File descriptor categories set forth in Table D below. The GL Account Balance and Totals categories provide a plurality of data fields. In one embodiment, each such category corresponds to a different column in the tabular output file. The following tables B-D provide a list of the categories of data which the user can add to, or exclude from, the customizable template:

TABLE B

| GL ACCOUNT BALANCE FIELDS | DESCRIPTION |
|---|---|
| Account - Subaccount | Displays Account + “-” + |
| | Subaccount for line detail. |
| Account Description | General Ledger Account |
| | Description matching the |
| | information accessible through |
| | the following link path at the |
| | home interface 434: Configure |
| | > Accounting > Chart of |
| | Accounts |
| Account Group Code | Account group code matching |
| | the information accessible |
| | through the following link path |
| | at the home interface 434: |
| | Configure > Accounting > Chart |
| | of Account Groups associated |
| | to GL Account |
| Account Group Description | Account group description |
| | matching the information |
| | accessible through the |
| | following link path at the home |
| | interface 434: Configure > |
| | Accounting > Chart of Account |
| | Groups associated to GL |
| | Account |
| Account Level | “Title” vs. “Subaccount”. |
| Account Status | Displays “Active” or “Inactive” |
| | matching the information |
| | accessible through the |
| | following link path at the home |
| | interface 434: Configure > |
| | Accounting > Chart of |
| | Accounts. |
| Accounting Month | Accounting Month |
| Agency Code | Agency code matching the |
| | information accessible through |
| | the following link path at the |
| | home interface 434: Configure |
| | > Structure > Agencies |
| Agency Name | Agency name matching the |
| | information accessible through |
| | the following link path at the |
| | home interface 434: Configure |
| | > Structure > Agencies |
| Amount | Displays debit or credit amount |
| | under a single column. If |
| | “Debit”, then positive; else |
| | negative. |
| Branch Code | Branch code matching the |
| | information accessible through |
| | the following link path at the |
| | home interface 434: Configure |
| | > Structure > Branches |
| Branch Name | Branch name matching the |
| | information accessible through |
| | the following link path at the |
| | home interface 434: Configure |
| | > Structure > Branches |
| Credit | Displays “Credit” amount. If |
| | “Debit”; displays blank. |
| Debit | Displays “Debit” amount. If |
| | “Credit”; display blank. |
| Department Code | Department code matching the |
| | information accessible through |
| | the following link path at the |
| | home interface 434: Configure |
| | > Structure > Departments |
| Department Name | Department name matching the |
| | information accessible through |
| | the following link path at the |
| | home interface 434: Configure |
| | > Structure > Departments |
| Group Type | General Ledger Account Type |
| | Code matching the information |
| | accessible through the |
| | following link path at the home |
| | interface 434: Configure > |
| | Accounting > Chart of |
| | Accounts. |
| Profit Center Code | Profit Center code matching the |
| | information accessible through |
| | the following link path at the |
| | home interface 434: Configure |
| | > Structure > Profit Centers |
| Profit Center Name | Profit Center name matching |
| | the information accessible |
| | through the following link path |
| | at the home interface 434: |
| | Configure > Structure > Profit |
| | Centers |
| Subaccount | Subaccount matching the |
| | information accessible through |
| | the following link path at the |
| | home interface 434: Configure |
| | > Accounting > Chart of |
| | Accounts |
| Title Account | Account matching the |
| | information accessible through |
| | the following link path at the |
| | home interface 434: Configure |
| | > Accounting > Chart of |
| | Accounts for “Title” or “Regular” |
| | accounts. |
| Title Account Description | Account description matching |
| | the information accessible |
| | through the following link path |
| | at the home interface 434: |
| | Configure > Accounting > Chart |
| | of Accounts for “Title” or |
| | “Regular” accounts. |
| Region Code | Region code matching the |
| | information accessible through |
| | the following link path at the |
| | home interface 434: Configure |
| | > Structure > Regions |
| Region Name | Region name matching the |
| | information accessible through |
| | the following link path at the |
| | home interface 434: Configure |
| | > Structure > Regions |

TABLE C

| TOTALS FIELDS | DESCRIPTION |
|---|---|
| Amount Balance | Total of single “Amount” |
| | column. Should be 0.00 if in |
| | balance. |
| Credit Account Balances | Total credits. |
| Debit Account Balances | Total debits. |
| Total Record Count | Counts the total number of |
| | detail lines in the Export file. |

TABLE D

| EXPORT FILE DESCRIPTORS | DESCRIPTION |
|---|---|
| Batch # | Batch Number for Export File. |
| Batch Description | Batch Description for Export file. |
| Criteria Date | Criteria date (based on format). |
| Criteria Month | Criteria month (based on format). |
| Entered Date | Batch entered date. |
| Entered Date & Time | Batch entered date + time. |
| Entered By | Batch entered by login. |
| File Description | Mapping File description. |
| File Destination | File destination |
| File Name | File name |

Using the data file mapping interface 496 and the customizable categories set forth in Tables B-D above, the user can define different data file templates, for example, templates X, Y and Z. For each template, the mapping interface 496 enables the user to enter a data output request or batch processing request. As a batch process, the system 400 feeds the output data files to the registered devices without requiring input or action from the user. The mapping interface 496 enables the user to specify a one-time data feed to the registered devices or automated, recurring data feeds to the registered devices. In one embodiment, for each template, the mapping interface 496 enables the user to specify the following batch settings for generating GL data files:

TABLE E

| BATCH SETTING | DESCRIPTION |
|---|---|
| Cancel Batch | The cancel batch setting prevents a data file |
| | from being generated. A user may provide this |
| | input if a batch is entered with erroneous |
| | criteria. |
| Export Batch | The export batch setting causes the system 400 |
| | to immediately output a data file for the selected |
| | batch. |
| Finalize Batch | The finalize batch setting protects an exported |
| | batch so that it is not modifiable or cancelable. |
| Modify Next | The finalize next scheduling/recurrence setting |
| Scheduling/Recurrence | cancels or reschedules one-time or recurring, |
| | future production requests for the selected |
| | batch. |

In one embodiment, the system 400 performs a General Ledger Consolidation (GLC) each time the output generator 428 outputs a GL data file. If, for example, the user sets the generator 428 to generate GL data files on a weekly basis, the system 400 would perform a GLC each week. In this embodiment, the system's most recently generated data file would include a comprehensive set of GL data, incorporating the data of the previous data file as well as any data changes or new data arising after the previous data file.

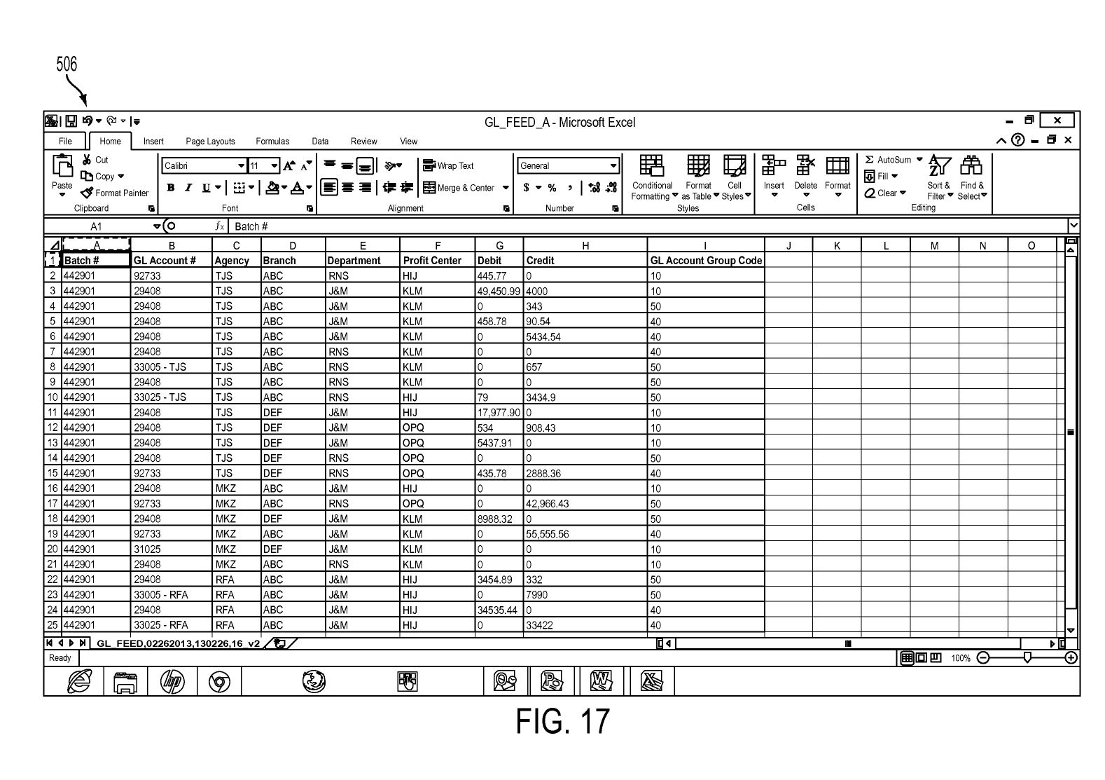

In one example, the user customizes a template with the following data categories for the column headings: Batch #, GL Account #, Agency, Branch, Department, Profit Center, Debit, Credit and GL Account Group Code. The output generator 428 produces a CSV data file populated with the financial GL data for such categories. The output generator 428 feeds that CSV file to a folder of a registered device. The user opens the folder, then opens the CSV file, and then saves a version of that file in Microsoft® Excel spreadsheet format as illustrated in FIG. 17. The example spreadsheet 506, shown in FIG. 17, sets forth the GL data in a tabular, editable format. The user can import the CSV file or Excel spreadsheet file into the user's financial software system 494.

It should be appreciated than any suitable software program can be run to view or edit the saved CSV data files. The format of the data file generated by the output generator 428 is tabular or otherwise configured for arrangement in rows and columns. In one embodiment, the data file has a plain text form including a plurality of data fields separated by breaks. The breaks can include commas or other symbols or suitable data dividers. In the plain text form, the user can open the data file and edit the data in the data file through a suitable editor or word processor, whether stored locally on the electronic device's hard drive or accessible over a network, including, but not limited to, Microsoft® Excel, online Google® Sheets or any suitable CSV editor.

In one embodiment, the system 400 has a user control or permission module. The permission module provides different privileges or rights associated with different users or user categories. The rights determine whether a user can create, set or change any of the system's configurable options described above. For example, an administrator user may have all available rights, including the right to register new network access devices; the right to remove devices from registration; the right to add, edit or delete data storage paths for devices; the right to add, edit or delete the data file templates for the output files; the right to add, edit or delete the batch processing settings for the output files; and the right to add, edit or cancel the rights of other users. A user other than the administrator may have a limited version of these rights based on the decisions made by the administrator.

Methods

In one embodiment, the system 400 is implemented as a method. The method includes some or all of the functionality, steps and logic of the system 400. In one embodiment, the method includes the following steps:
(a) electronically storing different categories of business data and a plurality of computer-readable instructions;
(b) electronically executing the computer-readable instructions to:
   (i) receive a plurality of settings, the settings including:
      (x) a path setting associated with a data storage destination, wherein the data storage destination is associated with an electronic device;
      (y) an output setting which specifies at least one of the categories of the business data to be included within an output data file;
      (z) a schedule setting which specifies how often the data storage destination is to receive the output data file; and
   (ii) send the output data file to the data storage destination in accordance with the settings, the output data file having a format which is importable into another system.

Network

Referring to FIGS. 4-6 and 15, the network 406 can be any suitable type of network. Depending upon the embodiment, the network 406 can include one or more of the following: a wired network, a wireless network, a local area network (LAN), an extranet, an intranet, a wide area network (WAN) (including, but not limited to, the Internet), a virtual private network (VPN), an interconnected data path across which multiple devices may communicate, a peer-to-peer network, a telephone network, portions of a telecommunications network for sending data through a variety of different communication protocols, a Bluetooth communication network, a radio frequency (RF) data communication network, an infrared (IR) data communication network, a satellite communication network or a cellular communication network for sending and receiving data through short messaging service (SMS), multimedia messaging service (MMS), hypertext transfer protocol (HTTP), direct data connection, Wireless Application Protocol (WAP), email or any other suitable message transfer service or format.

Hardware

Referring to FIGS. 4-7 and 15, in one embodiment, the system 400 includes a single server. In another embodiment, the system 400 includes multiple servers, each of which implements a different part of the system 400. In one embodiment, each of the one or more servers includes: (a) a processor (such as the processor 408) or a central processing unit (CPU); and (b) one or more data storage devices, including, but not limited to, a hard drive with a spinning magnetic disk, a Solid-State Drive (SSD), a floppy disk, an optical disk (including, but not limited to, a CD or DVD), a Random Access Memory (RAM) device, a Read-Only Memory (ROM) device (including, but not limited to, programmable read-only memory (PROM), erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

In one embodiment, each of the one or more servers is a general purpose computer. In one embodiment, the one or more servers function to deliver webpages at the request of clients, such as web browsers, using the Hyper-Text Transfer Protocol (HTTP). In performing this function, the one or more servers deliver Hyper-Text Markup Language (HTML) documents and any additional content which may be included, or coupled to, such documents, including, but not limited, to images, style sheets and scripts.

The network access devices 410 can include any device operable to access the network 406, including, but not limited to, a server, personal computer (PC) (including, but not limited to, a desktop PC, a laptop or a tablet), smart television, Internet-enabled TV, person digital assistant, smartphone, cellular phone or mobile communication device. In one embodiment, each network access device 410 has at least one input device (including, but not limited to, a touchscreen, a keyboard, a microphone, a sound sensor or a speech recognition device) and at least one output device (including, but not limited to, a speaker, a display screen, a monitor or an LCD).

Software

In one embodiment, the servers and network access devices each include a suitable operating system. Depending upon the embodiment, the operating system can include Windows, Mac, OS X, Linux, Unix, Solaris or another suitable computer hardware and software management system. In another embodiment, one or more of the network access devices includes a mobile operating system, including, but not limited to, Android, BlackBerry, iOS, Windows Phone and Windows RT.

In one embodiment, each of the network access devices has a browser operable by their processors to retrieve, present and traverse the following: (a) information resources on the one or more servers of the system 400; and (b) information resources on the World Wide Web portion of the Internet.

In one embodiment, the computer-readable instructions, algorithms and logic of the system 400 (including the computer-readable instructions and logic) are implemented with any suitable programming or scripting language, including, but not limited to, C, C++, Java, COBOL, assembler, PERL, Visual Basic, SQL Stored Procedures or Extensible Markup Language (XML). The output generator 428 of the system 400 can be implemented with any suitable combination of data structures, objects, processes, routines or other programming elements.

In one embodiment, the data storage device of the system 400 holds or stores web-related data and files, including, but not limited, to HTML documents, image files, Java applets, JavaScript, Active Server Pages (ASP), Common Gateway Interface scripts (CGI), XML, dynamic HTML, Cascading Style Sheets (CSS), helper applications and plug-ins.

In one embodiment, the graphical interfaces of the system 400 are Graphical User Interfaces (GUIs) structured based on a suitable programming language. The GUIs include, in one embodiment, windows, pull-down menus, buttons, scroll bars, iconic images, wizards, the mouse symbol or pointer, and other suitable graphical elements. In one embodiment, the GUIs incorporate multimedia, including, but not limited to, sound, voice, motion video and virtual reality interfaces.

In an alternative embodiment, the processor of each network accesses device 410 is programmed to extract or parse data from an interface of the system 400. In one embodiment, the system 400 includes an extract Application Programming Interfaces (API) which is downloadable to the network access devices 410. The API facilitates data communication between the network access devices 410 and the system processor 408, enabling the processors of the network access devices 410 to automatically extract the output data files from the system 400.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A system comprising:
a data storage device configured to store different categories of business data, the data storage device being accessible, over a network, by a processor and at least one electronic device, the electronic device being associated with at least one data storage destination; and
a plurality of instructions stored within the data storage device, the instructions being executable by the processor to:
(a) receive a plurality of settings, the settings including:
(i) a path setting associated with the data storage destination;
(ii) an output setting which specifies at least one of the categories of the business data to be included within an output data file; and
(iii) a schedule setting which specifies how often the data storage destination is to receive the output data file; and
(b) send the output data file to the data storage destination in accordance with the settings, the output data file having a format which is importable into another system.

2. The system of claim 1, wherein the data storage device is configured to store business data related to a business, the data storage device storing a plurality of data fields related to customers, vendors and invoicing.

3. The system of claim 2, wherein the business is an insurance agency management business, a plurality of the data fields being related to insured parties and insurance providers.

4. The system of claim 1, wherein the instructions are executable by the processor to send the output data file to the electronic device without requiring an input from a user of the electronic device.

5. A system comprising:
a data storage device configured to store different categories of business data related to a business, the data storage device storing a plurality of data fields related to customers, vendors and invoicing, the data storage device being accessible, over a network, by a processor and an electronic device, the electronic device having at least one data storage destination;
a first connection instruction set stored within the data storage device, the first connection instruction set being installable onto the electronic device;
a second connection instruction set stored within the data storage device, the second connection instruction set being executable by the processor to establish a connection with the electronic device without requiring input from a user; and
a plurality of instructions stored within the data storage device, the instructions being executable by the processor to:
(a) receive a plurality of settings, the settings including:
(i) a path setting associated with the data storage destination of the electronic device;
(ii) an output setting which specifies at least one of the categories of the business data to be included within an output data file;
(iii) a schedule setting which specifies how often the electronic device is to receive the output data file; and
(iv) a user permission setting which specifies a permission to change at least one of the settings; and
(b) send the output data file to the data storage destination in accordance with the settings, the output data file having a format which is importable into another system.

6. The system of claim 5, wherein the schedule setting specifies a recurring frequency for the processor to send the output data file to the data storage destination.

7. The system of claim 5, wherein the output data file has a plain text format, the plain text format being associated with a plurality of other data fields separated by breaks.

8. The system of claim 5, wherein the output data file includes a Comma Separated Value (CSV) data file.

9. The system of claim 5, wherein: (a) the business data includes different categories of financial data; (b) the output data file includes General Ledger data; and (c) the output setting specifies at least one of the categories of the financial data to be included within the output data file; and (d) a plurality of the instructions are executable by the processor to send the output data file to the data storage destination in accordance with the settings, the output data file having a format which is importable into a financial management system.

10. The system of claim 5, wherein the instructions are executable by the processor to: (a) receive a selection of at least one of the categories of business data; (b) store a data file template based on the selection; and (c) generate the output data file according to the data file template.

11. The system of claim 5, wherein the instructions are executable by the processor to: (a) receive a selection of at least one of a plurality of file descriptor categories; (b) generate file descriptor data corresponding to the selection; and (c) send the file descriptor data in association with the output data file.

12. A method comprising:
electronically storing different categories of business data and a plurality of computer-readable instructions; and
electronically executing the computer-readable instructions to:
(a) receive a plurality of settings, the settings including:
(i) a path setting associated with a data storage destination, the data storage device being associated with an electronic device;
(ii) an output setting which specifies at least one of the categories of the business data to be included within an output data file; and
(iii) a schedule setting which specifies how often the electronic device is to receive the output data file; and
(b) send the output data file to the data storage destination in accordance with the settings, the output data file having a format which is importable into another system.

13. The method of claim 12, which includes electronically storing business data related to a business, wherein the business data is related to customers, vendors and invoicing.

14. The method of claim 13, wherein the business is an insurance agency management business, the customers are insured parties, and the vendors are insurance providers.

15. The method of claim 12, which includes sending the output data file to the electronic device without requiring an input from a user of the electronic device.

16. The method of claim 12, wherein the schedule setting specifies a recurring frequency for the processor to send the output data file to the data storage destination.

17. The method of claim 12, wherein the output data file has a plain text format, the plain text format being associated with a plurality of other data fields separated by breaks.

18. The method of claim 12, wherein the output data file includes a Comma Separated Value (CSV) data file.

19. The method of claim 12, wherein the output data file includes General Ledger data.

20. The method of claim 12, which includes electronically executing the computer-readable instructions to: (a) receive a selection of at least one of the categories of business data; (b) store a data file template based on the selection; and (c) generate the output data file according to the data file template.
